(19) United States
(12) Patent Application Publication
(10) Pub. No.: US 2026/0155548 A1
(43) Pub. Date: Jun. 4, 2026

(54) SECONDARY BATTERY INCLUDING INSULATING MEMBER AND METHOD OF MANUFACTURING SECONDARY BATTERY

(71) Applicant: SAMSUNG SDI CO., LTD., Yongin-si (KR)

(72) Inventor: Dong Bok YANG, Yongin-si (KR)

(21) Appl. No.: 19/341,839

(22) Filed: Sep. 26, 2025

(30) Foreign Application Priority Data
Dec. 4, 2024 (KR) 10-2024-0178755

(51) Int. Cl. H01M 50/586; H01M 10/04; H01M 50/119; H01M 50/159; H01M 50/169; H01M 50/171; H01M 50/528; H01M 50/533; H01M 50/595

(52) U.S. Cl. CPC H01M 50/586; H01M 10/0431; H01M 50/119; H01M 50/159; H01M 50/169; H01M 50/171; H01M 50/528; H01M 50/533; H01M 50/595

(57) ABSTRACT

A secondary battery includes an electrode assembly including a first electrode, a separator, and a second electrode, the first electrode, the separator and the second electrode being wound; a case accommodating the electrode assembly; a first electrode tab connected to the first electrode; a second electrode tab connected to the second electrode; and an insulating member surrounding at least a portion of the first electrode tab or at least a portion of the second electrode tab, wherein the case accommodates the insulating member.

### CROSS-REFERENCE TO RELATED APPLICATION

The present application claims priority to and the benefit of Korean Application No. 10-2024-0178755, filed on Dec. 4, 2024, in the Korean Intellectual Property Office, the entire disclosure of which is incorporated by reference herein.

### BACKGROUND

### Field

The present disclosure relates to a secondary battery including an insulating member and a method of manufacturing the the secondary battery.

### Description of the Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Due to the structural characteristics of secondary batteries, secondary batteries carry a risk of internal short circuiting. If a short circuit occurs, swelling may occur due to internal gas generation caused by the decomposition of electrolyte and/or detrimental reactions occurring at the electrode. The swelling may cause the secondary battery to rupture, potentially leading to ignition or explosion due to thermal runaway and resulting in deterioration of battery performance and/or safety hazards.

In instances where the case of the secondary battery is formed of a metal, there is a need to install insulators in various regions of the secondary battery to prevent internal short circuits. to the drawback is that such installation of insulators may lead to an increased number of manufacturing processes and an increase in battery weight.

This Background section is for the general understanding of the background of the present disclosure, and therefore, it may contain information that does not constitute related (or prior) art.

### SUMMARY

These and other aspects and features of the present disclosure will be described in or will be apparent from the following description of embodiments of the present disclosure.

According to an embodiment of the present disclosure, a secondary battery may include an electrode assembly in which a first electrode, a separator, and a second electrode are wound, a case accommodating the electrode assembly, a first electrode tab connected to the first electrode, a second electrode tab connected to the second electrode, and an insulating member surrounding at least a portion of the first electrode tab or the second electrode tab, wherein the insulating member is accommodated inside the case.

Embodiments of the present disclosure provide a secondary battery including: an electrode assembly including a first electrode, a separator, and a second electrode, the first electrode, the separator and the second electrode being wound; a case accommodating the electrode assembly; a first electrode tab connected to the first electrode; a second electrode tab connected to the second electrode; and an insulating member surrounding at least a portion of the first electrode tab or at least a portion of the second electrode tab, wherein the case accommodates the insulating member.

In some embodiments, the secondary battery may further include a first electrode terminal, disposed on one side of the case and electrically connected to the first electrode through the first electrode tab, and a second electrode terminal, disposed on the one side of the case and electrically connected to the second electrode through the second electrode tab.

In some embodiments, the first electrode terminal and the first electrode tab may be in direct contact, or the second electrode terminal and the second electrode tab may be in direct contact.

In some embodiments, the insulating member surrounding at least a portion of the first electrode tab or the second electrode tab may be spaced apart from an inner surface of the case.

In some embodiments, the insulating member is spaced apart from an inner surface of the case.

In some embodiments, the insulating member may be disposed on both sides of the first electrode tab or the second electrode tab.

In some embodiments, the insulating member is disposed on both sides of the first electrode tab or both sides of the second electrode tab.

In some embodiments, the insulating member may be disposed on one side surface of the first electrode tab or the second electrode tab.

In some embodiments, the insulating member is disposed on one side surface of the first electrode tab or one side surface of the second electrode tab.

In some embodiments, the first electrode tab or the second electrode tab may be bent with the one side surface, on which the insulating member is disposed, oriented outward.

In some embodiments, the insulating member may include an adhesive layer and an insulating layer surrounding the adhesive layer.

In some embodiments, a thickness of the insulating layer may be about 18 to about 30 μm.

In some embodiments, the insulating layer may include a first resin layer and a second resin layer made of a material different from that of the first resin layer.

In some embodiments, the insulating layer comprises a first resin layer and a second resin layer, the second resin layer comprising a material different from a material of the first resin layer.

In some embodiments, the first resin layer or the second resin layer may include polyimide (PI), polyethylene terephthalate (PET), polypropylene (PP), polyethylene (PE), polystyrene (PS), acrylonitrile butadiene styrene(ABS), polyacetal (POM), polyvinyl chloride (PVC), polycarbonate (PC), nylon, polycaprolactone (PCL), polylactic acid (PLA), an acrylic (acrylic resin), a polyester (PET, PBT), celluloid, polytetrafluoroethylene (PTFE) (e.g., Teflon) , phenol formaldehyde resin (e.g., Bakelite), epoxy, melamine, amino, phenol, or a combination thereof.

In some embodiments, the case may include a body including a receiving portion for accommodating the electrode assembly and a flange portion extending around one open end of the receiving portion, a cover coupled to the flange portion to seal the open end of the receiving portion, and a bonding line disposed on the flange portion and on the cover corresponding to the flange portion, wherein the bonding line may include a welded portion where the flange portion and the cover are welded to each other or an adhered portion where the flange portion and the cover are bonded to each other via an adhesive.

In some embodiments, the case includes: a body including a receiving portion and a flange portion extending around one open end of the receiving portion; a cover configured to be coupled to the flange portion sealing the one open end; and a welded portion corresponding to a portion of the flange portion and a portion of the cover configured to be welded to each other or an adhered portion corresponding to the portion of the flange portion and the portion of the cover configured to be bonded to each other via an adhesive.

In some embodiments, the body and the cover may be formed of the same metallic material.

In some embodiments, both the body and the cover are comprise substantially identical metallic material.

In some embodiments, the metallic material may include stainless steel (SUS).

According to an embodiment of the present disclosure, a method of manufacturing a secondary battery may include winding a first electrode, a separator, and a second electrode to form an electrode assembly, surrounding at least a portion of a first electrode tab connected to the first electrode with a first insulating member, surrounding at least a portion of a second electrode tab connected to the second electrode with a second insulating member, and accommodating the electrode assembly in a case, wherein the first insulating member and the second insulating member are accommodated inside the case.

Embodiments of the present disclosure provide a method of manufacturing a secondary battery including: winding a first electrode, a separator, and a second electrode to form an electrode assembly; surrounding at least a portion of a first electrode tab with a first insulating member, the first electrode tab connected to the first electrode; surrounding at least a portion of a second electrode tab with a second insulating member, the second electrode tab connected to the second electrode; and accommodating the electrode assembly, the first insulating member, and the second insulating member in a case.

In some embodiments, the first insulating member or the second insulating member may include an adhesive layer and an insulating layer surrounding the adhesive layer.

In some embodiments, the step of surrounding at least a portion of the first electrode tab connected to the first electrode with the first insulating member may include disposing the first insulating member so that the adhesive layer faces the first electrode tab, and pressing at room temperature so as to attach the first insulating member to the first electrode tab.

In some embodiments, the surrounding at least a portion of the first electrode tab includes: disposing the first insulating member so that the adhesive layer faces the first electrode tab; and pressing the first insulating member to the first electrode tab.

In some embodiments, the method of manufacturing a secondary battery may further include electrically connecting a first electrode terminal, disposed on one side of the case, to the first electrode through the first electrode tab, and electrically connecting a second electrode terminal, disposed on one side of the case, to the second electrode through the second electrode tab.

In some embodiments, the method further includes: electrically connecting a first electrode terminal, disposed on one side of the case, to the first electrode through the first electrode tab; and electrically connecting a second electrode terminal, disposed on one side of the case, to the second electrode through the second electrode tab.

In some embodiments, the step of electrically connecting the first electrode terminal to the first electrode may include welding the first electrode terminal to the first electrode tab.

In some embodiments, the electrically connecting the first electrode terminal comprises welding the first electrode terminal to the first electrode tab.

In some embodiments, the step of accommodating the electrode assembly in the case may include bending the first electrode tab or the second electrode tab so that the one side surface on which the first insulating member or the second insulating member is disposed is oriented outward.

In some embodiments, the accommodating includes bending the first electrode tab or the second electrode tab so that one side surface of the first electrode tab or one side surface of the second electrode tab, on which the first insulating member or the second insulating member is disposed, respectively, is oriented outward.

According to some embodiments of the present disclosure, it is possible to provide a secondary battery that, without additional processes, prevents in advance an internal short circuit that may occur between the case of the secondary battery and an electrode tab.

According to some embodiments of the present disclosure, by omitting the thermal fusion process for attaching the insulator to the electrode tab compared to the related art, an insulating member made of a material having a high melting point may be used. This can protect the electrode tab without melting the insulating member even if the internal temperature of the cell becomes high, thereby improving overall cell safety performance.

### BRIEF DESCRIPTION OF DRAWINGS

The drawings illustrate embodiments of the present disclosure, and further describe aspects and features of the present disclosure along with the detailed description of the present disclosure. Thus, the present disclosure should not be construed as being limited to the drawings:

FIG. 1 is a schematic diagram illustrating a secondary battery according to embodiments of the present disclosure.

FIG. 2 is a cross-sectional view illustrating a longitudinal section of a secondary battery according to embodiments of the present disclosure.

FIG. 3 is a diagram illustrating a periphery of an electrode tab of a secondary battery according to embodiments of the present disclosure.

FIG. 4 is a plan view and a cross-sectional view illustrating an electrode tab provided with an insulating member according to embodiments of the present disclosure.

FIG. 5 is a plan view and a cross-sectional view illustrating an electrode tab provided with an insulating member according to embodiments of the present disclosure.

FIG. 6 is a plan view and a cross-sectional view illustrating an electrode tab provided with an insulating member according to embodiments of the present disclosure.

FIG. 7 is a plan view and a cross-sectional view illustrating an electrode tab provided with an insulating member according to embodiments of the present disclosure.

FIG. 8 is a flowchart illustrating a method of manufacturing a secondary battery according to embodiments of the present disclosure.

FIG. 9 is a diagram illustrating a step of surrounding an electrode tab with an insulating member according to embodiments of the present disclosure.

FIG. 10 is a diagram illustrating a conventional method of surrounding an electrode tab with an insulator according to a comparative example.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value greater than or equal to 1.0 and a maximum value less than or equal to 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked,” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

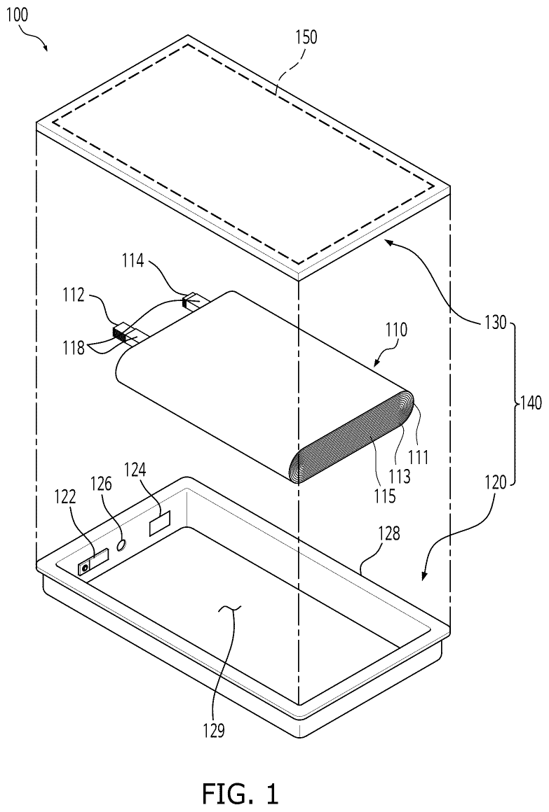

FIG. 1 is a schematic diagram illustrating a secondary battery.

Referring to FIG. 1, a secondary battery 100 may include an electrode assembly 110 in which a first electrode 111, a separator 115, and a second electrode 113 are wound; a case 140 accommodating the electrode assembly 110; a first electrode tab 112 connected to first electrode 111; a second electrode tab 114 connected to second electrode 113; and an insulating member 118 surrounding at least a portion of first electrode tab 112 or second electrode tab 114. Insulating member 118 may be accommodated within case 140.

According to an embodiment, electrode assembly 110 may be formed by sequentially winding or stacking first electrode 111, separator 115, and second electrode 113. For example, electrode assembly 110 may be formed by sequentially winding first electrode 111, separator 115, and second electrode 113 to form a jelly-roll configuration. A cavity may be formed in the interior (winding core portion) of the jelly roll, where first electrode 111, separator 115, and second electrode 113 are absent.

Electrode assembly 110 may be impregnated with an electrolyte (not shown). The electrolyte may include a liquid electrolyte, a solid electrolyte, a gel electrolyte, or a combination thereof.

First electrode 111 may be a positive electrode or a negative electrode in electrode assembly 110. Second electrode 113 may be an electrode of a polarity opposite that of first electrode 111. For example, when first electrode 111 is a positive electrode, second electrode 113 may be a negative electrode. Conversely, when first electrode 111 is a negative electrode, second electrode 113 may be a positive electrode.

The positive electrode and the negative electrode are wound after interposing the separator, which is an insulator, therebetween. However, the present disclosure is not limited thereto, and the electrode assembly may have a structure in which a positive electrode and a negative electrode, each made of a plurality of sheets, are alternately stacked with a separator interposed therebetween.

A positive electrode for a rechargeable lithium battery may include a current collector and a positive electrode active material layer on the current collector. The positive electrode active material layer may include a positive electrode active material and may further include a binder and/or a conductive material(e.g., an electrically conductive material).

For example, the positive electrode may include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles to one another and also to attach the positive electrode active material to the current collector. Non-limiting examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, or the like.

The conductive material ensures conductivity (e.g., electrical conductivity) to the electrode. Any material that does not cause a detrimental chemical change (e.g., does not cause an undesirable chemical change in the rechargeable lithium battery) and conducts electrons can be used in the battery.

Non-limiting examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but is not limited thereto.

The separator may include polyethylene, polypropylene, polyvinylidene fluoride, or a multilayer film of two or more layers thereof, and a mixed multilayer film such as a

### Polyethylene/polypropylene Two-layer Separator, a

polyethylene/polypropylene/polyethylene three-layer separator, a polypropylene/polyethylene/polypropylene three-layer separator, and the like.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles to one another and also to attach the negative electrode active material to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may include a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose-based compound capable of imparting viscosity may be included. The cellulose-based compound may include carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may include polytetrafluoroethylene, polyvinylidene fluoride, a polyvinylidene fluoride-hexafluoropropylene copolymer, polyethylene oxide, or a combination thereof.

The conductive material ensures conductivity (e.g., electrical conductivity) to the electrode. Any material that does not cause a detrimental chemical change (e.g., does not cause an undesirable chemical change in the rechargeable lithium battery) and conducts electrons can be used in the battery.

Non-limiting examples of the conductive material may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The separator may include a porous substrate and a coating layer including an organic material, an inorganic material, or a combination thereof on one or both surfaces of the porous substrate.

The porous substrate may include a polymer film including polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and the inorganic material may be mixed in one coating layer, or a coating layer including an organic material and a coating layer including an inorganic material may be stacked.

For example, first electrode 111 may form a positive electrode by coating a positive electrode active material on an aluminum (Al) substrate, and second electrode 113 may form a negative electrode by coating a negative electrode active material on a copper (Cu) substrate.

First electrode tab 112 may be formed by extending the metal substrate included in first electrode 111 or by connecting a separate metal substrate to the metal substrate of first electrode 111, in particular, to a first non-coating portion, so that it protrudes from one surface of electrode assembly 110. Second electrode tab 114 may be formed by extending the metal substrate included in second electrode 113 or by connecting a separate metal substrate to the metal substrate of second electrode 113, in particular, to a first non-coating portion, so that it protrudes from one surface of electrode assembly 110.

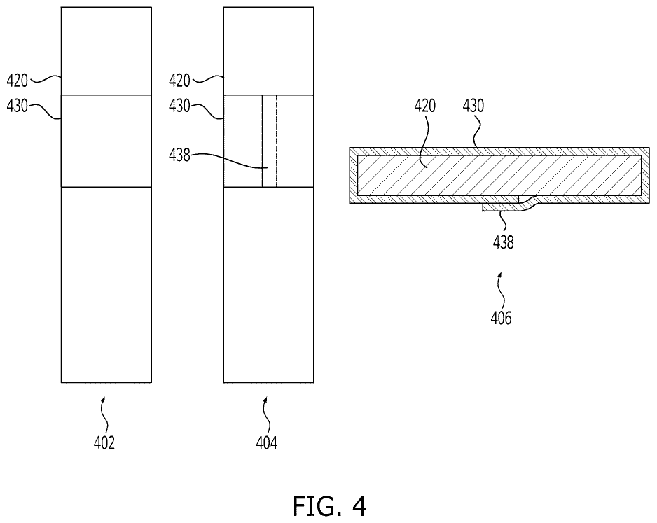

Insulating member 118 may surround at least a portion of first electrode tab 112 or second electrode tab 114. The geometry in which insulating member 118 surrounds first electrode tab 112 or second electrode tab 114 is described with reference to FIGS. 4 through 7.

Case 140 forms the overall appearance of secondary battery 100 and may include a conductive metal such as aluminum, an aluminum alloy, or steel plated with nickel. Body 120 and cover 130 may be formed of substantially the same metallic material. Here, the metallic material may include stainless steel (SUS) or aluminum (Al). However, case 140 may be formed of various metallic materials that satisfy the required strength and impact resistance for a secondary battery.

Body 120 may include a receiving portion 129 that has one open end to accommodate electrode assembly 110. Receiving portion 129 of body 120 may be formed so as to provide an interior space in which electrode assembly 110 is housed, for example, by using a press or the like. Although the planar geometry of receiving portion 129 of case 140 may be rectangular as illustrated, it is not limited thereto.

Cover 130 may be formed as a flat plate disposed on flange portion 128 of body 120 so as to seal the open end of receiving portion 129. For example, cover 130 may be formed as a flat plate of sufficient size to cover flange portion 128, allowing surface contact with flange portion 128. The lower surface of cover 130 and the upper surface of flange portion 128 may be in surface contact. When flange portion 128 and cover 130 are coupled, body 120 and cover 130 may form a single structure.

A case 140 for a secondary battery may include flange portion 128 and a bonding line 150 disposed on flange portion 128 and on cover 130 corresponding to flange portion 128. Bonding line 150 may refer to the region where flange portion 128 and cover 130 are joined so as to seal receiving portion 129. For example, bonding line 150 may include a welded portion where flange portion 128 and cover 130 are welded to each other via a laser welder. Bonding line 150 may include an adhered portion where flange portion 128 and cover 130 are bonded to each other with an adhesive. Bonding line 150 may be formed along the edges of cover 130 and flange portion 128.

In an embodiment, secondary battery 100 may include a first electrode terminal 122 disposed on one side of case 140 and electrically connected to first electrode 111, and a second electrode terminal 124 disposed on one side of case 140 and electrically connected to second electrode 113. First electrode terminal 122 may be electrically connected to first electrode 111 through first electrode tab 112, and second electrode terminal 124 may be electrically connected to second electrode 113 through second electrode tab 114.

According to some embodiments, first electrode terminal 122 and first electrode tab 112 may be in direct contact. Second electrode terminal 124 and second electrode tab 114 may be in direct contact.

For example, first electrode tab 112 may be welded to first electrode terminal 122. A portion of first electrode terminal 122 may protrude in the direction of electrode assembly 110 on one side of case 140 so as to be welded to first electrode tab 112. Second electrode tab 114 may be welded to second electrode terminal 124. A portion of second electrode terminal 124 may protrude in the direction of electrode assembly 110 on one side of case 140 so as to be welded to second electrode tab 114.

First electrode tab 112 may be welded to first electrode terminal 122, and second electrode tab 114 may be welded to second electrode terminal 124 using ultrasonic welding, laser welding, resistance welding, tungsten inert gas welding (TIG welding), or a combination thereof. The welding method is not limited to the enumerated welding types, and various methods commonly used for welding two materials may be chosen by those skilled in the art.

In an embodiment, case 140 may include an electrolyte injection port 126. For example, electrolyte injection port 126 may be formed as a through-hole on at least one side of case 140 and may be formed to allow an electrolyte to be introduced into case 140 after body 120 and cover 130 are joined and sealed. After the electrolyte is introduced, electrolyte injection port 126 may be sealed with a sealing member.

In an embodiment, first electrode terminal 122 and second electrode terminal 124 may be coupled to body 120. For example, first electrode terminal 122 and second electrode terminal 124 may be disposed on at least one side of case 140, specifically on at least one side of body 120. The positions of first electrode terminal 122 and second electrode terminal 124 are not limited to those illustrated in FIG. 1, and various modifications are possible.

Secondary battery 100 shown in FIG. 1 may be a can-type secondary battery formed of stainless use steel (SUS), but the secondary battery is not limited thereto and may be any one of various types of secondary batteries such as a prismatic secondary battery formed of aluminum.

For example, secondary battery 100 may be a lithium battery cell or a sodium battery cell. However, secondary battery 100 may include any type of battery that can repeatedly provide electricity through charging and discharging. In an embodiment, when secondary battery 100 is a lithium battery cell, it may have excellent lifespan characteristics and high-rate characteristics, making it suitable for use in electric vehicles (EV). For example, it may be used in a hybrid vehicle such as a plug-in hybrid electric vehicle (PHEV). The lithium battery cell may be used in a variety of fields requiring a range of power storage, for example, in smartphones, tablet PCs, electric bicycles, and electric power tools, but is not limited thereto.

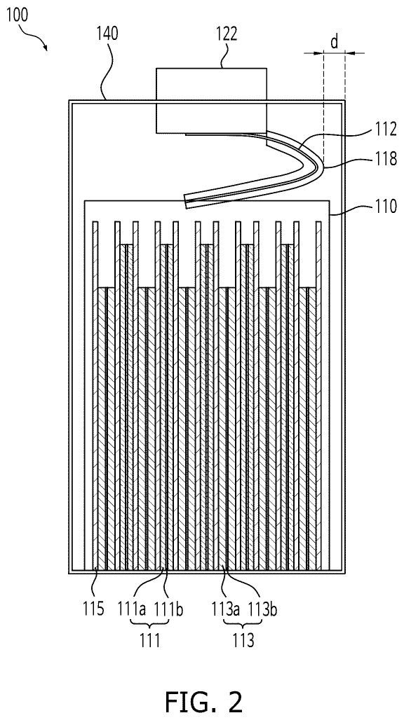

FIG. 2 is a cross-sectional view illustrating a longitudinal section of a secondary battery. Referring to FIG. 2, according to some embodiments, first electrode terminal 122 and first electrode tab 112 may be in direct contact. Although not shown in FIG. 2, the second electrode terminal may have substantially the same structure and arrangement as first electrode terminal 122, and the second electrode tab may have substantially the same structure and arrangement as first electrode tab 112. For example, the second electrode terminal and the second electrode tab may be in direct contact.

A portion of first electrode tab 112 that is in direct contact with first electrode terminal 122 may be absent of insulating member 180. In this manner, as described with reference to FIG. 1, first electrode tab 112, which is made of metal, may be welded to first electrode terminal 122, which is made of metal. A portion of first electrode terminal 122 may protrude in the direction of electrode assembly 110 on one side of case 140 so as to be welded to first electrode tab 112. First electrode terminal 122 may pass through one side of case 140 so that first electrode 111 is connected to the outside of secondary battery 100.

According to some embodiments, the insulating member 118 that surrounds at least a portion of first electrode tab 112 or a second electrode tab (not shown) may be spaced apart from the inner surface of case 140. A distance (d) between insulating member 118 and the inner surface of case 140 may be about 0.01 mm to about 15 mm, about 0.01 mm to about 1.5 mm, or about 0.01 mm to about 0.5 mm. In this manner, insulating member 118 may be completely accommodated inside case 140 without contacting case 140.

According to some embodiments, the first electrode tab 112 or the second electrode tab may be bent such that the one side on which the insulating member 118 is disposed is oriented outward. The first electrode tab 112 or the second electrode tab, which has the insulating member 118 applied, may be bent at least once in order to be accommodated inside case 140. When bent, the side with the insulating member 118 may be oriented toward case 140. In this manner, insulating member 118 may be interposed between the first electrode tab 112 or the second electrode tab and case 140, electrically insulating the space between the first electrode tab 112 and case 140 or between the second electrode tab and case 140 to prevent internal short circuits.

In an embodiment, electrode assembly 110 may include first electrode 111 and second electrode 113. First electrode 111 includes a first active material 111a coated on both surfaces of a thin metal plate forming a first substrate 111b, and a first non-coating portion, which is an area where first active material 111a is not coated so that first substrate 111b is exposed. Second electrode 113 includes a second active material 113a coated on both surfaces of a thin metal plate forming a second substrate 113b, and a second non-coating portion, which is an area where second active material 113a is not coated so that second substrate 113b is exposed.

First electrode tab 112 may be formed by extending first substrate 111b included in first electrode 111 or by connecting a separate metal substrate to first substrate 111b included in first electrode 111, in particular to the first non-coating portion, so as to protrude from one surface of electrode assembly 110. Second electrode tab 114 may be formed by extending second substrate 113b included in second electrode 113 or by connecting a separate metal substrate to second substrate 113b included in second electrode 113, in particular to the second non-coating portion, so as to protrude from one surface of electrode assembly 110. For example, first electrode tab 112 may include a plurality of metal pieces formed by notching the first non-coating portion in a strip shape.

According to some embodiments, it is possible to provide a secondary battery that prevents in advance an internal short circuit that may occur between case 140 of secondary battery 100 and an electrode tab (for example, first electrode tab 112) without additional processes.

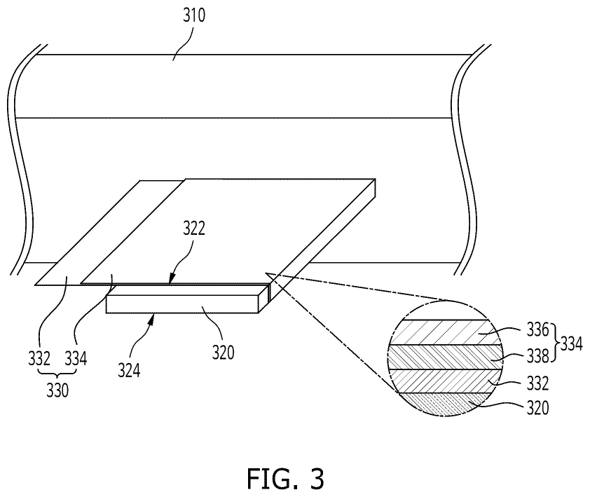

FIG. 3 is a diagram illustrating a periphery of an electrode tab of a secondary battery.

Referring to FIG. 3, a first electrode tab 320 may be formed to protrude from one surface of an electrode assembly 310. An insulating member 330 may surround at least a portion of first electrode tab 320.

According to some embodiments, insulating member 330 may include an adhesive layer 332 and an insulating layer 334 surrounding adhesive layer 332. A thickness of insulating layer 334 may be about 10 to about 60 μm, about 15 to about 40 μm, or about 18 to about 30 μm.

In an embodiment, adhesive layer 332 may include an epoxy adhesive material, a carbon-based adhesive material, a silicone-based adhesive material, an anisotropic adhesive material, or a combination thereof. The material for adhesive layer 332 is not limited to the above embodiment, and various adhesion methods that can bond insulating layer 334 and first electrode tab 320 to each other may be used.

According to some embodiments, insulating layer 334 may include a first resin layer 336 and a second resin layer 338 made of a material different from that of first resin layer 336. In an embodiment, first resin layer 336 or second resin layer 338 may be manufactured by using alone or mixing a thermoplastic resin, a thermosetting resin, and a composite material.

For example, first resin layer 336 or second resin layer 338 may include polyimide (PI), polyethylene terephthalate (PET), polypropylene (PP), polyethylene (PE), polystyrene (PS), acrylonitrile butadiene styrene(ABS), polyacetal (POM), polyvinyl chloride (PVC), polycarbonate (PC), nylon, polycaprolactone (PCL), polylactic acid (PLA), an acrylic (acrylic resin), a polyester (PET, PBT), celluloid, polytetrafluoroethylene (PTFE)(e.g., Teflon), phenol formaldehyde resin(e.g., Bakelite), epoxy, melamine, amino, phenol, or a combination thereof. For example, first resin layer 336 may include polyimide, and second resin layer 338 may include polyethylene.

Although not shown, insulating layer 334 may include a third resin layer (not shown) made of a material different from that of first resin layer 336 and second resin layer 338. The third resin layer may include polyimide (PI), polyethylene terephthalate (PET), polypropylene (PP), polyethylene (PE), polystyrene (PS), acrylonitrile butadiene styrene(ABS), polyacetal (POM), polyvinyl chloride (PVC), polycarbonate (PC), nylon, polycaprolactone (PCL), polylactic acid (PLA), an acrylic (acrylic resin), a polyester (PET, PBT), celluloid, polytetrafluoroethylene(PTFE)(e.g., Teflon), phenol formaldehyde resin (e.g., Bakelite), epoxy, melamine, amino, phenol, or a combination thereof.

According to some embodiments, insulating member 330 may be disposed on both surfaces of first electrode tab 320. Insulating member 330 may be disposed on a first surface 322 of first electrode tab 320 and a second surface 324 opposite first surface 322. Insulating member 330 may be disposed to surround both surfaces of first electrode tab 320.

Insulating member 330 may be disposed on one side surface of first electrode tab 320. Insulating member 330 may be disposed on either first surface 322 of first electrode tab 320 or second surface 324 opposite first surface 322. Insulating member 330 may be disposed to surround a portion of first electrode tab 320, while another portion of first electrode tab 320 remains exposed.

Details regarding the shape of insulating member 330 are described with reference to FIGS. 4 through 7.

Although not shown in FIG. 3, the second electrode tab may have substantially the same structure and arrangement as first electrode tab 320.

FIGS. 4 through 7 are plan views and cross-sectional views illustrating electrode tabs 420, 520, 620, 720 having insulating members 430, 530, 630, 730 attached thereto. FIGS. 4 through 7 illustrate geometries 402, 502, 602, 702 as viewed from the direction of first surface 322 in FIG. 3, geometries 404, 504, 604, 704 as viewed from the direction of second surface 324 in FIG. 3, and cross-sections 406, 506, 606, 706 of electrode tabs 420, 520, 620, 720.

Referring to FIGS. 4 through 6, according to an embodiment, insulating members 430, 530, 630 may be disposed on both side surfaces of electrode tabs 420, 520, 620.

Referring to FIG. 4, insulating member 430 may be formed as a single piece and disposed in a manner that surrounds both surfaces of electrode tab 420. This may create an overlapping portion 438 on one side surface of electrode tab 420, where both ends of insulating member 430 overlap.

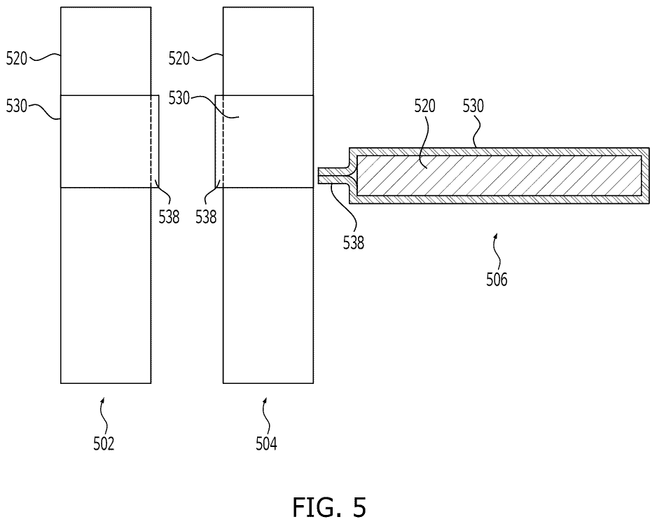

Referring to FIG. 5, insulating member 530 may be formed as a single piece and disposed in a manner that surrounds both sides of electrode tab 520. This may create an overlapping portion 538 on one surface of electrode tab 520, where both ends of insulating member 530 overlap. Overlapping portion 538 may be formed along the short side of the cross-section of electrode tab 520, different from overlapping portion 438 depicted in FIG. 4.

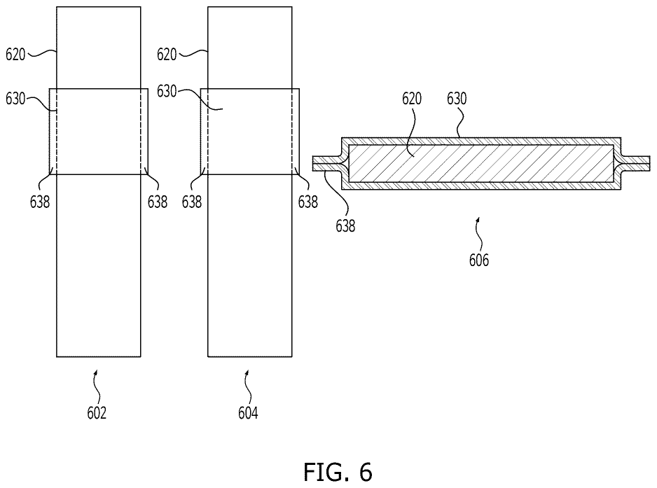

Referring to FIG. 6, the insulating member 630 may include two tapes, and these tapes may be disposed in such a way that each tape wraps around opposing faces of electrode tab 620, and face each other. This configuration may result in the formation of an adhering portion 638 on one surface of electrode tab 620 where both ends of each tape meet. The adhering portion 638 can be formed along the short side of the cross-section of electrode tab 620, different from the overlapping portion 438 depicted in FIG. 4.

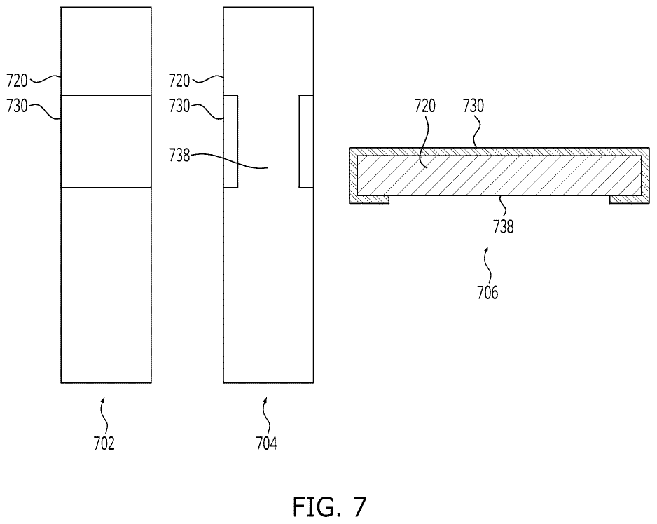

Referring to FIG. 7, an insulating member 730 may be disposed on one side surface of electrode tab 720. Insulating member 730 may surround one side surface of electrode tab 720, and on the portion of electrode tab 720 opposite that one side surface, an exposed portion 738 may be present where insulating member 730 is absent.

As described with reference to FIG. 2, electrode tab 720 may be bent such that the one side surface on which insulating member 730 is disposed, initially oriented outward, is bent to ultimately face the case. Electrode tab 720 having insulating member 730 disposed thereon may be bent at least once to be accommodated inside the case. The one side surface on which insulating member 730 is disposed may face the case, that is, being bent so that exposed portion 738 is located in the interior.

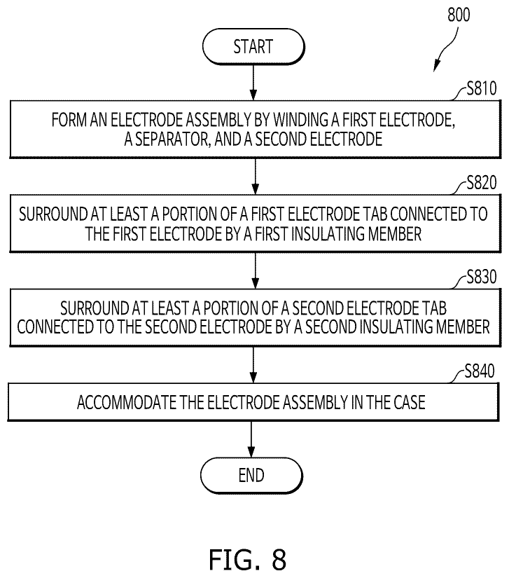

FIG. 8 is a flowchart illustrating a method (800) of manufacturing a secondary battery.

A method (800) of manufacturing a secondary battery may include forming an electrode assembly by winding a first electrode, a separator, and a second electrode (S810).

At least a portion of a first electrode tab connected to the first electrode may be surrounded by a first insulating member (S820). At least a portion of a second electrode tab connected to the second electrode may be surrounded by a second insulating member (S830). The order of these two steps is not limited. The first insulating member or the second insulating member may include an adhesive layer and an insulating layer surrounding the adhesive layer.

The electrode assembly may be accommodated in the case (S840). The first insulating member and the second insulating member may be accommodated in the case along with the electrode assembly. According to an embodiment, the step of accommodating the electrode assembly in the case (S840) may include bending the first electrode tab or the second electrode tab so that the one side surface on which the first insulating member or the second insulating member is disposed is oriented outward.

The method (800) of manufacturing a secondary battery may include electrically connecting a first electrode terminal, disposed on one side of the case, to the first electrode through the first electrode tab, and electrically connecting a second electrode terminal, disposed on one side of the case, to the second electrode through the second electrode tab. The step of electrically connecting the first electrode terminal to the first electrode may include welding the first electrode terminal to the first electrode tab. The step of electrically connecting the second electrode terminal to the second electrode may include welding the second electrode terminal to the second electrode tab.

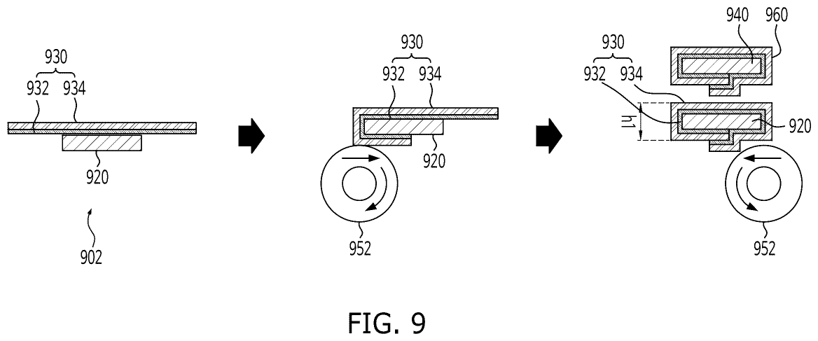

FIG. 9 is a diagram illustrating a step of surrounding an electrode tab with an insulating member.

According to some embodiments, the step of surrounding at least a portion of a first electrode tab connected to the first electrode with a first insulating member (S820 in FIG. 8) may include: disposing a first insulating member 930 so that an adhesive layer 932 faces first electrode tab 920; and pressing at room temperature to attach first insulating member 930 to first electrode tab 920.

First insulating member 930 may include adhesive layer 932 and insulating layer 934. In order to surround first electrode tab 920 with first insulating member 930, adhesive layer 932 may be arranged so as to face first electrode tab 920. In an embodiment, one end of first insulating member 930 may be pressed through a roller 952 against first electrode tab 920, so that it is attached.

In an embodiment, the other end of first insulating member 930 may be pressed via roller 952 to be attached to first electrode tab 920. The thickness (h1) of the combination where the first electrode tab 920 and the first insulating member 930 are attached to each other may be about 100 to about 200 μm, about 110 to about 150 μm, or about 116 to about 140 μm.

In a similar manner, a second insulating member 960 may be attached to second electrode tab 940.

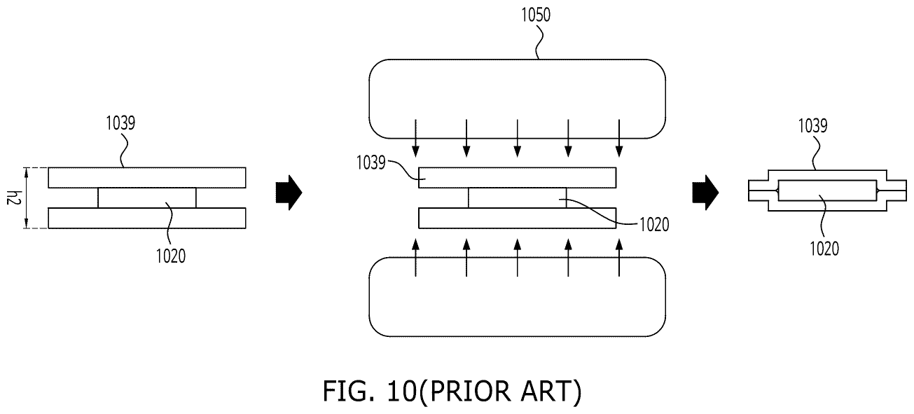

FIG. 10 is a diagram illustrating a conventional method of surrounding an electrode tab with an insulator according to a comparative example.

Thermal fusion process has been conventionally used in manufacturing an electrode tab 1020 surrounded by an insulator 1039. The thermal fusion process in the comparative example may begin by disposing electrode tab 1020 between insulator 1039. The thickness (h2) of a combination in which electrode tab 1020 and insulator 1039 are attached to each other may be 200 to 400 μm, 210 to 350 μm, or 230 to 340 μm.

Thereafter, heat press 1050 may press insulator 1039 and electrode tab 1020 while heating insulator 1039 above its melting point, so that insulator 1039 clings to electrode tab 1020 and forms a shape that surrounds electrode tab 1020. For example, the melting point of insulator 1039 may be 180° C., and heat press 1050 may heat insulator 1039 to 160-200° C. In the comparative example, this forming process may be carried out simultaneously during the step of heat-sealing the case of the secondary battery by placing electrode tab 1020 and insulator 1039 between the case.

In the combination manufactured through this process, only a material with a low melting point is used for insulator 1039 for molding purposes, leading to the disadvantage that insulator 1039 may melt in instances where the internal environment of the secondary battery has a temperature meeting or exceeding the low melting point. In the combination manufactured in this manner, electrode tab 1020 may be deformed during the thermal fusion process.

According to some embodiments, by omitting the thermal fusion process for attaching the insulator to the electrode tab, an insulating member made of a material having a high melting point may be used. Even when the internal temperature of the cell is relatively high, the insulating member does not melt. In this manner, the electrode tab can be preserved improving overall cell safety performance. The melting point of the insulating member according to some embodiments may be about 320 to about 360° C.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF NOTABLE COMPONENTS

100: secondary battery
110: electrode assembly
111: first electrode
112: first electrode tab
113: second electrode
114: second electrode tab
115: separator
118: insulating member
120: body
122: first electrode terminal
124: second electrode terminal
126: electrolyte injection port
128: flange portion
129: receiving portion
130: cover
140: case
150: bonding line

What is claimed is:

1. A secondary battery comprising:
an electrode assembly comprising a first electrode, a separator, and a second electrode, the first electrode, the separator and the second electrode being wound;
a case accommodating the electrode assembly;
a first electrode tab connected to the first electrode;
a second electrode tab connected to the second electrode; and
an insulating member surrounding at least a portion of the first electrode tab or at least a portion of the second electrode tab,
wherein the case accommodates the insulating member.

2. The secondary battery according to claim 1, further comprising:
a first electrode terminal disposed on one side of the case and electrically connected to the first electrode through the first electrode tab; and
a second electrode terminal disposed on the one side of the case and electrically connected to the second electrode through the second electrode tab.

3. The secondary battery according to claim 2,
wherein the first electrode terminal and the first electrode tab are in direct contact, or
wherein the second electrode terminal and the second electrode tab are in direct contact.

4. The secondary battery according to claim 1, wherein the insulating member is spaced apart from an inner surface of the case.

5. The secondary battery according to claim 1, wherein the insulating member is disposed on both sides of the first electrode tab or both sides of the second electrode tab.

6. The secondary battery according to claim 1, wherein the insulating member is disposed on one side surface of the first electrode tab or one side surface of the second electrode tab.

7. The secondary battery according to claim 6, wherein the first electrode tab or the second electrode tab is bent with the one side surface, on which the insulating member is disposed, oriented outward.

8. The secondary battery according to claim 1, wherein the insulating member comprises an adhesive layer and an insulating layer surrounding the adhesive layer.

9. The secondary battery according to claim 8, wherein a thickness of the insulating layer is about 18 to about 30 μm.

10. The secondary battery according to claim 8, wherein the insulating layer comprises a first resin layer and a second resin layer, the second resin layer comprising a material different from a material of the first resin layer.

11. The secondary battery according to claim 10, wherein the first resin layer or the second resin layer comprises polyimide (PI), polyethylene terephthalate (PET), polypropylene (PP), polyethylene (PE), polystyrene (PS), acrylonitrile butadiene styrene (ABS), polyacetal (POM), polyvinyl chloride (PVC), polycarbonate (PC), nylon, polycaprolactone (PCL), polylactic acid (PLA), an acrylic (acrylic resin), a polyester (PET, PBT), celluloid, polytetrafluoroethylene(PTFE), phenol formaldehyde resin, epoxy, melamine, amino, phenol, or a combination thereof.

12. The secondary battery according to claim 1, wherein the case comprises:
a body comprising a receiving portion and a flange portion extending around one open end of the receiving portion;
a cover configured to be coupled to the flange portion sealing the one open end; and
a welded portion corresponding to a portion of the flange portion and a portion of the cover configured to be welded to each other or an adhered portion corresponding to the portion of the flange portion and the portion of the cover configured to be bonded to each other via an adhesive.

13. The secondary battery according to claim 12, wherein both the body and the cover are comprise substantially identical metallic material.

14. The secondary battery according to claim 13, wherein the metallic material comprises stainless use steel (SUS).

15. A method of manufacturing a secondary battery comprising:
winding a first electrode, a separator, and a second electrode to form an electrode assembly;
surrounding at least a portion of a first electrode tab with a first insulating member, the first electrode tab connected to the first electrode;
surrounding at least a portion of a second electrode tab with a second insulating member, the second electrode tab connected to the second electrode; and
accommodating the electrode assembly, the first insulating member, and the second insulating member in a case.

16. The method according to claim 15, wherein the first insulating member or the second insulating member comprises an adhesive layer and an insulating layer surrounding the adhesive layer.

17. The method according to claim 16, wherein the surrounding at least a portion of the first electrode tab comprises:
disposing the first insulating member so that the adhesive layer faces the first electrode tab; and
pressing the first insulating member to the first electrode tab.

18. The method according to claim 15, further comprising:
electrically connecting a first electrode terminal, disposed on one side of the case, to the first electrode through the first electrode tab; and
electrically connecting a second electrode terminal, disposed on one side of the case, to the second electrode through the second electrode tab.

19. The method according to claim 18, wherein the electrically connecting the first electrode terminal comprises welding the first electrode terminal to the first electrode tab.

20. The method according to claim 15, wherein the accommodating comprises bending the first electrode tab or the second electrode tab so that one side surface of the first electrode tab or one side surface of the second electrode tab, on which the first insulating member or the second insulating member is disposed, respectively, is oriented outward.
